(19) United States
(12) Patent Application Publication
(10) Pub. No.: US 2009/0148670 A1
(43) Pub. Date: Jun. 11, 2009

(54) Acrylic material structure for furniture

(76) Inventor: Mei-Ping Chen, Futain Village (TW)

Correspondence Address: Dr. BANGER SHIA, 102 Lindencrest Ct., Sugar Land, TX, 77479-5201, US

(21) Appl. No.: 11/952,734

(22) Filed: Dec. 7, 2007

(51) Int. Cl. B32B 3/02

(52) U.S. Cl. 428/192

(57) ABSTRACT

An acrylic material structure for furniture comprises a filling member, a plurality of acrylic sheets, hardening coating and acrylic cement. With the combination of these structures, compared with the solid acrylic furniture or the acrylic material, under the same appearance and strength, it can achieve the advantages: low cost and light weight, capable of meeting different thickness requirements.

### BACKGROUND OF THE INVENTION

1. Field of the Invention

The present invention relates to a material structure for furniture, and more particularly to a surface hardening acrylic material structure for furniture.

2. Description of the Prior Art

In order to pursue a simple residence style, the modern people sometimes expect a simple but elegant decoration. For meeting the requirements of the modern decoration, the streamlined and functional furniture or the original decoration materials have been rapidly substituting the market position of the traditional materials and furniture, and the occident fashion has been gradually spreading all over the world. Since acrylic material has a good flexibility and can be added with different color pigments during manufacturing process to achieve a product with any desired color, acrylic furniture is gradually becoming more and more popular in the furniture market. More particularly to the decoration materials made of the above material, the demand is greatly increased. However, the existing acrylic materials for furniture still have the following problems:

First, the product is restricted to have too small thickness: the conventional acrylic is only applicable to the furniture capable of loading a relatively small gravity, such as CD rack, due to the characteristics of itself. For example, the existing technologies all base on the grouting method, when the formed thickness is larger than 100 mm, and the superposition time is longer than 20 days, the operation time is relatively long, resulting in the increase of the operational cost. In addition, if the acrylic formed thickness is too large, it will cause too large dry-forming velocity difference between the surface and the central portion thereof during the superposition process, thus making the product surface uneven or present a depressed state;

Second, excessively high material cost: the acrylic base material formed by the existing grouting technology must be grouted with the acrylic raw material the amount of which is equal to or even more than that of the final forming thickness required material, so as to be formed as an ideal required state, thus leading to an excessively high material cost;

Third, overweight: the acrylic basic material formed by the existing grouting technology has a quite heavy weight, so it is not convenient for the fabrication of the large-scale furniture;

Fourth, if the conventional acrylic is formed too thin, it is likely to fall to pieces or directly cause injury to the user due to the fragile characteristic of the material, so it is unfavorable for the furniture or the decoration materials that must load the foundation stress.

The present invention has arisen to mitigate and/or obviate the afore-described disadvantages.

### SUMMARY OF THE INVENTION

The primary objective of the present invention is to solve the disadvantages of the existing conventional acrylic furniture, such as, excessively thick, excessively high cost and over weight, so as to widen the application range of the acrylic material.

Hence, in order to achieve the above objective, the present invention comprises a filling member, a plurality of surface hardening acrylic sheets completely cladding the filling member, and acrylic cement coated on the connecting edges of the acrylic sheets to closely bind the acrylic sheets together. With the technology of the present invention, under the same product appearance and strength, the material thickness of the acrylic sheet and the production cost can be easily reduced and the weight of the product can be greatly reduced.

### BRIEF DESCRIPTION OF THE DRAWINGS

FIG. 1 is a cross sectional view of a conventional acrylic material for furniture;

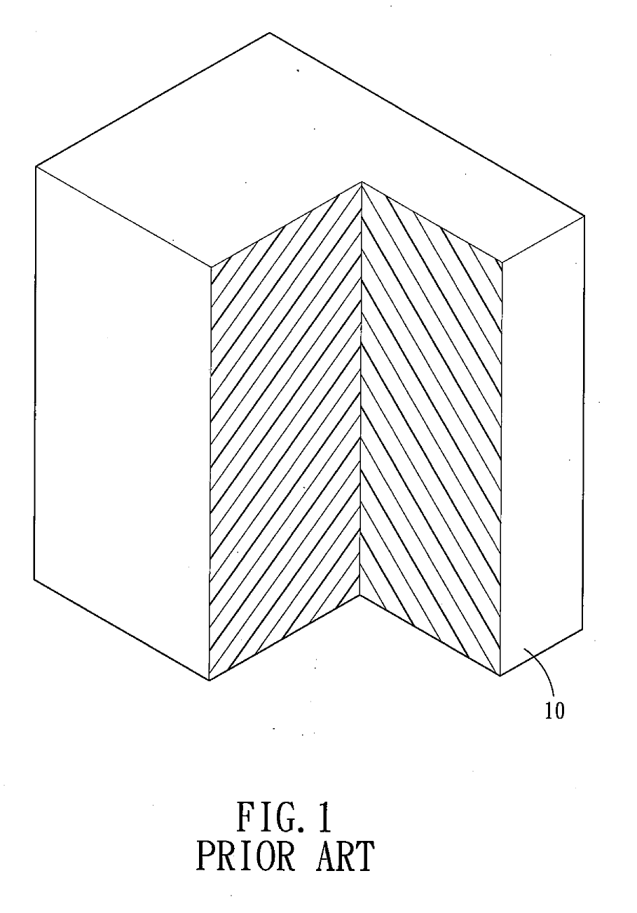

FIG. 2 is a cross sectional view of an acrylic material structure for furniture in accordance with the present invention;

FIG. 3 is a cross sectional view of an acrylic material structure for furniture in accordance with the present invention;

FIG. 4 is a schematic view showing that the acrylic material structure for furniture is applied as a chair; and

FIG. 5 is a partial schematic view showing that the acrylic material structure for furniture is applied as a chair.

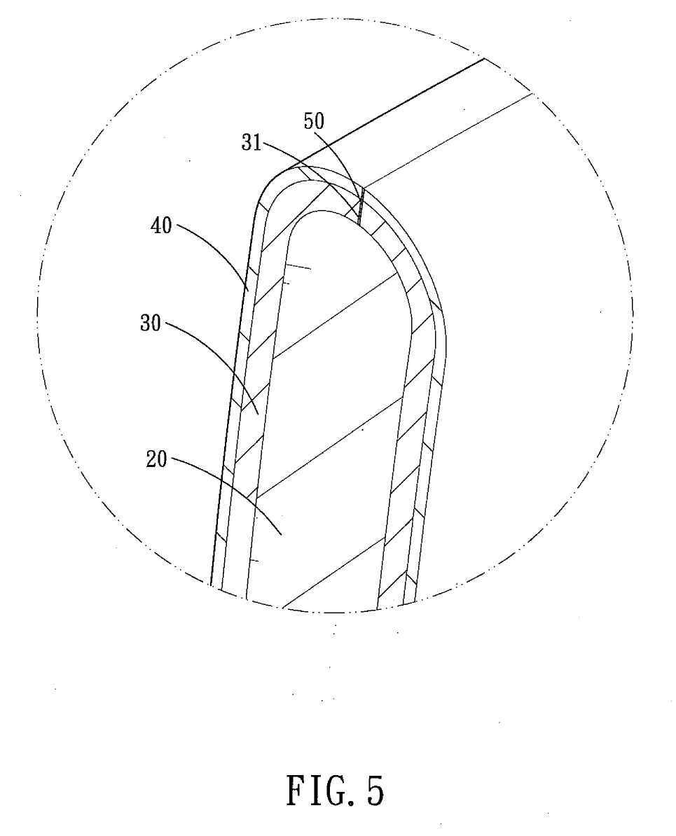

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

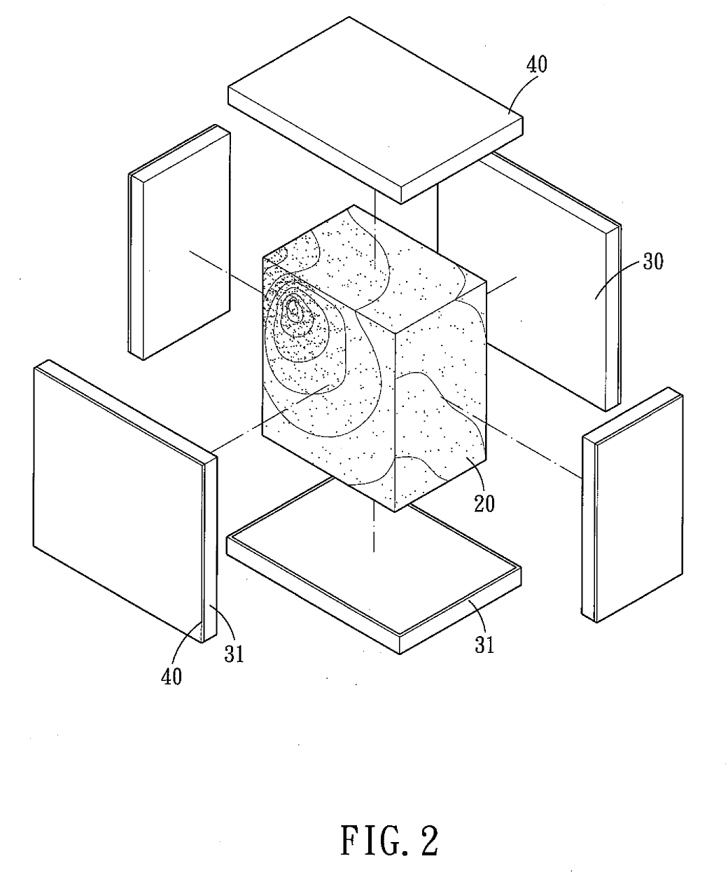

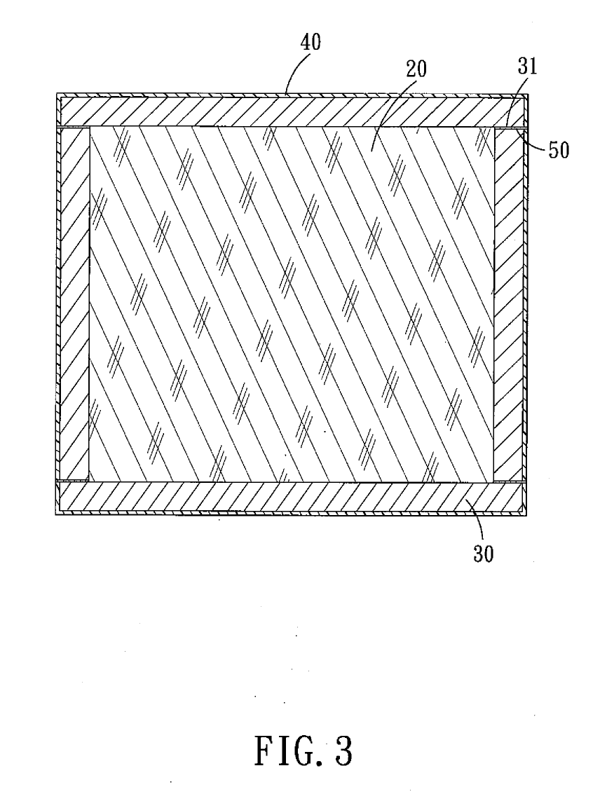

Referring to FIGS. 2-3, an acrylic material structure for furniture in accordance with a preferred embodiment of the present invention comprises a filling member 20, a plurality of acrylic sheets 30, hardening coating 40 and acrylic cement 50.

The filling member 20 is made of a hard material such as, the solid wood or the material of which the specific gravity (1.2) is less than that of the acrylic.

Each acrylic sheet 30 is coated with hardening coating 40 on the surface thereof. The hardening coating 40 can be made of the silica gel or epoxy resin, which is naturally dried after being uniformly coated on the surface of the acrylic sheet 30. The acrylic sheets 30 are disposed outside the filling member 20, and each end edge of the respective acrylic sheets 30 is formed as a connecting edge 31. The respective acrylic sheets 30 are connected with each other through the connecting edges 31. Each acrylic sheet 30 has a thickness between 0.5 mm and 70 mm.

The acrylic cement 50 is coated on the connecting edges 31 of the predetermined acrylic sheets 30 to bind the two adjacent acrylic sheets 30 together. The acrylic cement 50 may be dichloromethane.

The aforementioned is the summary of the positional and structural relationship of the respective components of the preferred embodiment in accordance with the present invention.

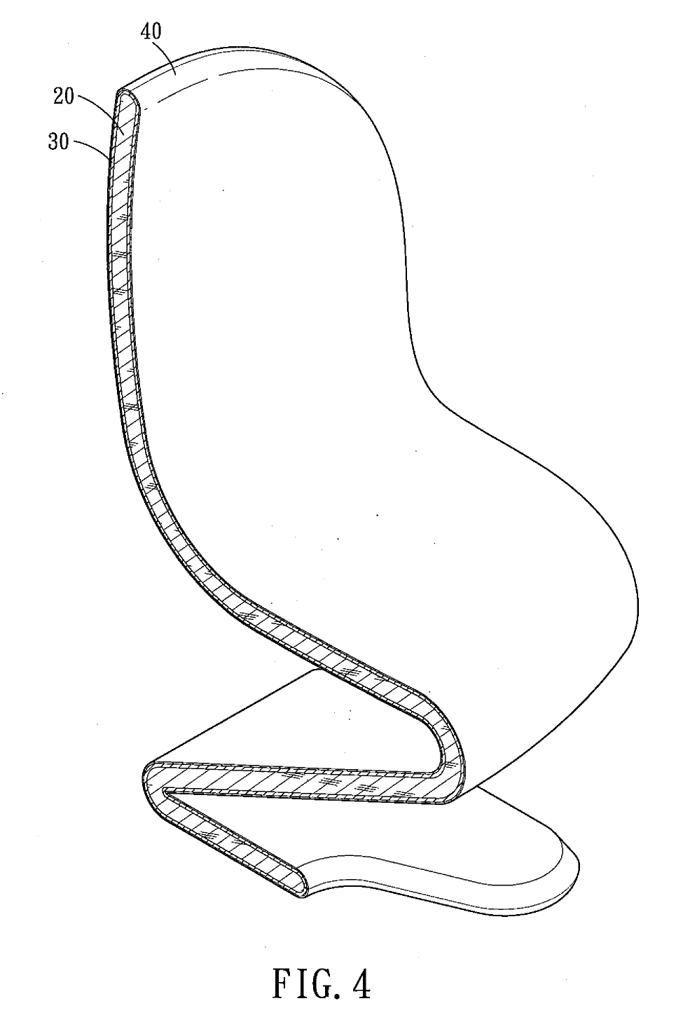

For a better understanding of the present invention, its wide application to any furniture or material, reference should be made to FIG. 4:

For a wide application to any furniture, according to different processing requirements, besides the hard material such as solid wood, etc, the filling member 20 can also be made of composite material that is formed into a predetermined shape by press forming of the reclaimed wood pellet. The acrylic sheet 30 only needs to be shaped correspondingly to the external shape of the filling member 20. Each end edge of the respective acrylic sheets 30 is formed with a connecting edge 31, and the connecting edges 30 are coated with the acrylic cement 50, so that the respective acrylic sheets 30 can be closely bond together to completely clad the filling member 20.

Hence, compared with the conventional acrylic material structure for furniture, under the same appearance and strength, the present invention has the following advantages:

First, the thickness of the acrylic furniture or the decoration foundation material is arbitrarily controlled by the producer without any limitations;

Second, in terms of the same specification, the cost of the acrylic material structure for furniture of the present invention is greatly reduced by 90% with respect to the conventional grouting technology;

Third, after the surface hardening, the strength of the acrylic surface will be improved, thus providing a safer choice for the user who has the requirement of stress on the acrylic material structure for furniture;

Fourth, the weight is reduced, so that the common consumers all can easily finish the furniture arrangement;

Fifth, the filling member can be made of a reclaimed material, satisfying the environment protection requirements.

To summarize, the present invention utilizes a filling member, a plurality of surface hardening acrylic sheets and acrylic cement to solve the problems of the conventional acrylic material structure for furniture.

While we have shown and described various embodiments in accordance with the present invention, it is clear to those skilled in the art that further embodiments may be made without departing from the scope of the present invention.

What is claimed is:

1. An acrylic material structure for furniture comprising:
a filling member made of a hard material;
a plurality of acrylic sheets being disposed outside the filling member, each end edge of the respective acrylic sheets being formed as a connecting edge, and adjacent acrylic sheets being bond together through the connecting edges;
hardening coating being coated on surfaces of the acrylic sheets; and
acrylic cement being coated on the connecting edges of the acrylic sheets to bind the adjacent acrylic sheets together.

2. The acrylic material structure for furniture as claimed in claim 1, wherein the filling material is made of wood.

3. The acrylic material structure for furniture as claimed in claim 1, wherein the acrylic sheet has a thickness between 0.5 mm and 70 mm.

4. The acrylic material structure for furniture as claimed in claim 1, wherein the cement is dichloromethane.

5. The acrylic material structure for furniture as claimed in claim 1, wherein the hardening coating is silica gel or epoxy resin.
